(19) United States
(12) Patent Application Publication
(10) Pub. No.: US 2021/0024372 A1
(43) Pub. Date: Jan. 28, 2021

(54) FILTER FOR WATER PURIFIER AND WATER PURIFIER INCLUDING THE SAME

(71) Applicant: LG Electronics Inc., Seoul (KR)

(72) Inventors: Suhye WOO, Seoul (KR); Sangduck LEE, Seoul (KR); Yuseung CHOI, Seoul (KR)

(21) Appl. No.: 16/866,292

(22) Filed: May 4, 2020

(30) Foreign Application Priority Data
Jul. 22, 2019 (KR) 10-2019-0088481

(51) Int. Cl. C02F 1/00; C02F 1/28; C02F 1/44

(52) U.S. Cl. CPC C02F 1/001; C02F 1/283; C02F 2101/12; C02F 1/447; C02F 2201/007; C02F 1/444

(57) ABSTRACT

A filter for a water treatment apparatus includes a filter housing that defines an inlet of the filter and an outlet of the filter, and a filter module disposed inside the filter housing and configured to purify water received through the inlet and supply purified water to the outlet. The filter module includes a carbon block that has a hollow tube-shape and that comprises a mixture of activated carbon and a binder, and a non-woven fabric that surrounds an outer circumferential surface of the carbon block, the non-woven fabric comprising an electrostatic attraction material. The filter module is configured to receive water through the inlet, transmit the water through the non-woven fabric and the carbon block in sequence to thereby purify the water, and then discharge the purified water to the outlet of the filter.

### CROSS-REFERENCE TO RELATED APPLICATION

This application claims a benefit under 35 U.S.C. § 119(a) of Korean Patent Application No. 10-2019-0088481, filed on Jul. 22, 2019, in the Korean Intellectual Property Office, the entire disclosure of which is incorporated herein by reference for all purposes.

### TECHNICAL FIELD

The present specification relates to a filter for a water purifier having an electrostatic attraction function and a water purifier having the same.

### BACKGROUND

The water purifier is an apparatus that can purify raw water, such as tap water or groundwater. For example, the water purifier may be an apparatus for converting the raw water into drinking water through various water purification schemes and providing the drinking water.

In some cases, in order to produce purified water, the raw water may be processed through precipitation, filtration, sterilization, and the like. The harmful substances may be removed through the processes.

The water purifier may be equipped with various filters to purify the raw water. In some cases, these filters may be classified into a sediment filter, an activated carbon filter, a (ultrafiltration) UF hollow fiber membrane filter, a reverse osmosis (RO) membrane filter, and the like.

The sediment filter may precipitate contaminants or floating matters with large particles in the raw water. The activated carbon filter may adsorb and remove contaminants, residual chlorine, volatile organic compounds, or odor-causing factors with small particles.

The activated carbon filter may include two activated carbon filters. For instance, the activated carbon filter may include a pre carbon filter provided at a raw water side and a post carbon filter provided at a purified water side. The post carbon filter may improve taste of water by removing the odor-causing substances that mainly affect the taste of the purified water.

In some cases, the UF hollow fiber membrane filter and the RO membrane filter may be used selectively.

Recently, a demand for the water purifier has increased significantly. Therefore, various requirements are generated and there may be a problem that it is difficult to satisfy the various requirements at the same time.

For example, a heavy metal may be removed by applying the RO membrane filter, but it may be difficult to secure a flow rate of the purified water. That is, it may take a long time to obtain an amount of purified water as desired.

In some cases, where the UF hollow fiber membrane filter is used, although a high flow rate may be secured, it may be difficult to use groundwater or tap water in a contaminated region as the raw water since it may be difficult to remove the heavy metal in the water.

In some cases, both of the heavy metal removal and the high flow rate securement may be desired. In some cases, it may be difficult to secure the high flow rate when using the RO membrane filter to remove the heavy metal; in some cases, it may be difficult to remove the heavy metal when using the UF hollow fiber membrane filter to secure the high flow rate.

In some examples, where a carbon block is used as a single filter, it may be difficult to remove viruses and bacteria. In some examples, where several filters are equipped individually, a volume of the filter may be increased.

In some cases, an UF filter or an electrostatic attraction filter, which is a chemical product, may cause change in taste of water.

### SUMMARY

The present disclosure describes a filter for a water purifier and a water purifier including the same that may secure a flow passage along which water flowed into a filter housing is discharged out of the filter housing after passing through a UF filter, an electrostatic attraction filter, and a carbon block in order.

The present disclosure describes a filter for a water purifier and a water purifier including the same that may include a UF filter, an electrostatic attraction filter, and a carbon block arranged in a single filter housing.

The present disclosure describes a filter for a water purifier and a water purifier including the same that may more reliably remove particulate matter, bacteria, and viruses contained in water.

The present disclosure describes a filter for a water purifier and a water purifier including the same that allows taste of water finally supplied to a user not to be altered.

The present disclosure describes a filter for a water purifier and a water purifier including the same that may be applied directly to an existing water purifier without changing a shape or arrangement of the filter applied to the water purifier.

The present disclosure describes a filter for a water purifier and a water purifier including the same that may increase space utilization by reducing a volume of the filter by longitudinally disposing a heterogeneous filter in a single filter housing.

According to one aspect of the subject matter described in this application, a filter for a water treatment apparatus includes a filter housing that defines an inlet of the filter and an outlet of the filter, and a filter module disposed inside the filter housing and configured to purify water received through the inlet and supply purified water to the outlet. The filter module includes a carbon block that has a hollow tube-shape and that includes a mixture of activated carbon and a binder, and a non-woven fabric that surrounds an outer circumferential surface of the carbon block. The non-woven fabric includes an electrostatic attraction material. The filter module is configured to receive water through the inlet, transmit the water through the non-woven fabric and the carbon block in sequence to thereby purify the water, and then discharge the purified water to the outlet of the filter.

Implementations according to this aspect may include one or more of the following features. For example, the non-woven fabric may have a wrinkled shape arranged along a circumference of the carbon block. In some examples, the non-woven fabric may include a plurality of convex portions that protrude outward relative to the circumference of the carbon block and a plurality of concave portions, each of the plurality of concave portions being disposed between the plurality of convex portions.

In some implementations, the filter may further include a fiber membrane filter including a hollow fiber membrane that is disposed inside the filter housing and that is positioned vertically below the non-woven fabric and the carbon block. The fiber membrane filter may be configured to receive water entered into the filter housing and then transmit water upward to the non-woven fabric and the carbon block.

In some implementations, the filter may further include: a first inner cover that is accommodated inside the filter housing, that defines an outer surface of the fiber membrane filter, and that covers the hollow fiber membrane; and a second inner cover that is accommodated inside the filter housing, that is disposed vertically above the first inner cover, and that covers an outer surface of the non-woven fabric.

In some examples, the first inner cover may define a communication hole at a lower position of the first inner cover, the communication hole being configured to communicate water between an outside of first inner cover and an inside of the first inner cover, and an inner surface of the filter housing and outer surfaces of the first and second inner covers may define a first flow passage configured to guide downward water entered into the filter housing to the inside of the first inner cover through the communication hole.

In some examples, the fiber membrane filter may be configured to receive and filter water entered into the inside of the first inner cover through the communication hole and to discharge the water in an upward direction from the inside of the first inner cover to the second inner cover.

In some implementations, the filter may further include a filter bracket seated on a top portion of the fiber membrane filter and coupled to bottom portions of the carbon block and the non-woven fabric. The filter bracket may define a second flow passage between the top portion of the fiber membrane filter and a bottom portion of the filter bracket, the second flow passage being configured to guide water discharged upward from the fiber membrane filter.

In some examples, the filter bracket may include an extension that protrudes downward and that extends along a circumference of the filter bracket, the filter bracket defining a through groove that is recessed upward relative to a bottom of the extension. The through groove may correspond to a through hole that is defined between the extension and the top portion of the fiber membrane filter and that is configured to discharge water guided through the second flow passage into a third flow passage defined between the outer surface of the non-woven fabric and an inner surface of the second inner cover.

In some implementations, the carbon block may define a hollow portion that is configured to receive water having been guided by the third flow passage and then passed through the non-woven fabric and the carbon block, the hollow portion being configured to discharge water in the upward direction out of the filter housing. In some implementations, a top portion of the first inner cover is inserted into a bottom portion of the second inner cover, and the filter further may include a sealing member inserted between the top portion of the first inner cover and the bottom portion of the second inner cover.

In some implementations, the non-woven fabric may include a rectangular fabric that is pleated into a closed curve shape and that has ends thermally bonded to each other, where the non-woven fabric contacts the outer circumferential surface of the carbon block.

According to another aspect, a water treatment apparatus includes at least one filter configured to produce purified water from raw water. The at least one filter includes a filter housing that defines an inlet of the filter and an outlet of the filter, and a filter module disposed inside the filter housing and configured to purify water received through the inlet and supply purified water to the outlet. The filter module includes a carbon block that has a hollow tube-shape and that includes a mixture of activated carbon and a binder, and a non-woven fabric that surrounds an outer circumferential surface of the carbon block, where the non-woven fabric includes an electrostatic attraction material. The filter module is configured to receive water through the inlet, transmit the water through the non-woven fabric and the carbon block in sequence to thereby purify the water, and then discharge the purified water to the outlet of the filter.

Implementations according to this aspect may include one or more of the following features. For example, the filter may further include a fiber membrane filter including a hollow fiber membrane that is disposed inside the filter housing and that is positioned vertically below the non-woven fabric and the carbon block. The fiber membrane filter may be configured to receive water entered into the filter housing and then transmit water upward to the non-woven fabric and the carbon block.

In some implementations, the at least one filter may further include a first inner cover that is accommodated inside the filter housing, that defines an outer surface of the fiber membrane filter, and that covers the hollow fiber membrane, and a second inner cover that is accommodated inside the filter housing, that is disposed vertically above the first inner cover, and that covers an outer surface of the non-woven fabric. In some examples, the first inner cover may define a communication hole at a lower position of the first inner cover, and the communication hole may be configured to communicate water between an outside of first inner cover and an inside of the first inner cover. An inner surface of the filter housing and outer surfaces of the first and second inner covers may define a first flow passage configured to guide downward water entered into the filter housing to the inside of the first inner cover through the communication hole.

In some implementations, the fiber membrane filter may be configured to receive and filter water entered into the inside of the first inner cover through the communication hole and then discharge the water in an upward direction from the inside of the first inner cover to the second inner cover.

In some implementations, the at least one filter may further include a filter bracket seated on a top portion of the fiber membrane filter and coupled to bottom portions of the carbon block and the non-woven fabric. The filter bracket may define a second flow passage between the top portion of the fiber membrane filter and a bottom portion of the filter bracket, the second flow passage being configured to guide water discharged upward from the fiber membrane filter.

In some examples, the filter bracket may include an extension that protrudes downward and that extends along a circumference of the filter bracket, and the filter bracket may define a through groove that is recessed upward relative to a bottom of the extension. The through groove may correspond to a through hole that is defined between the extension and the top portion of the fiber membrane filter and that is configured to discharge water guided through the second flow passage into a third flow passage defined between the outer surface of the non-woven fabric and an inner surface of the second inner cover.

In some implementations, the carbon block may define a hollow portion that is configured to receive water having been guided by the third flow passage and then passed through the non-woven fabric and the carbon block, and the hollow portion may be configured to discharge water in the upward direction out of the filter housing.

In some implementations, the filter may define the flow passage along which the water flowed into the filter housing is discharged out of the filter housing after passing through the UF filter, the electrostatic attraction filter, and the carbon block in order.

In some implementations, the UF filter, the electrostatic attraction filter, and the carbon block may be arranged in the single filter housing.

In some implementations, a specific surface area of the electrostatic attraction non-woven fabric may be increased so that a life time of the filter may be lengthened.

In some implementations, the particulate matter, the bacteria, and the viruses contained in the water may be more reliably removed.

In some implementations, the taste of the water finally supplied to the user may be prevented from being altered.

In some implementations, the water purification process may take place several times by the plurality of filters so that the removal of the various foreign substances including the heavy metals may be more reliably performed.

In some implementations, where only the material of the filter is changed and the shape or arrangement of the filter applied to the water purifier is not changed, the filter of the present disclosure may be directly applied to the existing water purifier.

In some implementations, the heterogeneous filter may be longitudinally disposed in the single filter housing to reduce the volume of the filter. Thus, the space utilization may be improved and further the water purifier may be implemented slimly.

### BRIEF DESCRIPTION OF THE DRAWINGS

FIG. 1 is a water pipe diagram illustrating an example of a water purifier.

FIG. 2 is a conceptual diagram illustrating an example of a filter assembly.

FIG. 3 is a cross-sectional view illustrating an example of a pre carbon filter.

FIG. 4 is a cross-sectional view illustrating an example of a composite filter.

FIG. 5 is a perspective view illustrating an example of a post carbon filter from which a second inner cover is separated.

FIG. 6 is a top plan view illustrating an example of a post carbon filter from which a second inner cover is separated.

FIG. 7 is a perspective view illustrating the post carbon filter shown in FIG. 5 coupled with an example of a hollow fiber membrane filter.

FIG. 8 is a perspective view illustrating an example of a filter including a post carbon filter and a hollow fiber membrane filter coupled to each other.

FIG. 9 is a table showing example components to be removed by individual filters and a composite filter.

FIGS. 10A and 10B are views illustrating examples of removal mechanisms of chromium (Cr) and selenium (Se) on an electrostatic attraction non-woven fabric.

### DETAILED DESCRIPTION

Hereinafter, one or more implementations of the present disclosure will be described in detail with reference to the drawings. However, the spirit of the present disclosure is not limited to implementations to be presented below. Those skilled in the art who understand the spirit of the present disclosure may readily implement other implementations that fall within the scope of the same idea by adding, modifying, deleting, and adding components, but it will also be within the scope of the present disclosure.

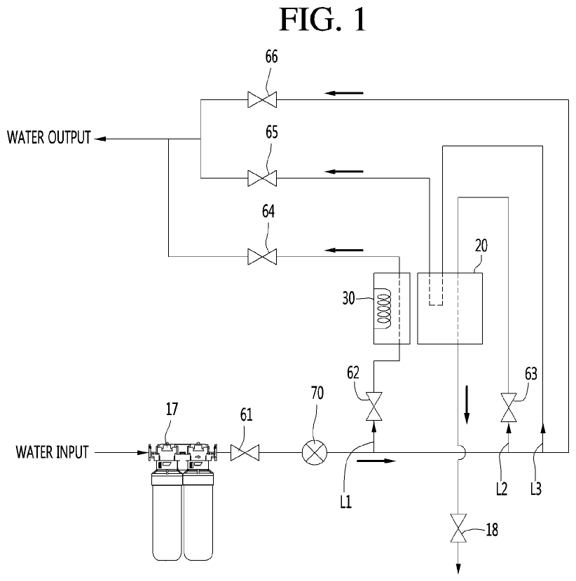

FIG. 1 is a water pipe diagram of a water purifier.

A water purifier is to purify water supplied directly from an external water source, then cool or heat the purified water, and then discharge the cooled or heated water. For example, the water purifier may be a direct-type cold and warmth water purifier.

In some implementations, the direct-type water purifier may refer to a water purifier in which purified water is extracted according to a user's purified water extraction operation without a reservoir for storing the purified water therein.

In some examples, the water purifier may be formed integrally with a refrigerator.

In some examples, the water purifier may be an under-sink water purifier that includes a body installed at a lower portion of a sink and that has a water discharge hole defined outside the sink.

Referring to FIG. 1, the water purifier may include a water supply line L that extends from a water supply source to the water discharge hole of the water purifier, and various valves and water purification parts may be connected to the water supply line L. The water supply line L may include one or more pipes, one or more hoses, or any combination thereof

In more detail, the water supply line L may be connected to the water supply source, such as a faucet in home or the like. Further, a filter assembly 17 is disposed at an arbitrary point of the water supply line L to filter foreign substances contained in drinking water supplied from the water supply source.

In implementations, a water supply valve 61 and a flow rate sensor 70 may be sequentially arranged on the water supply line L connected to an outlet end of the water supply line L. Therefore, when a supply amount detected by the flow rate sensor 70 reaches a set flow rate, the water supply valve 61 may be controlled to close.

In some examples, the water supply line L may include a water supply line L1 for supplying hot water, a water supply line L3 for supplying cold water, and a water supply line L2 for supplying cooling water that may be branched at an arbitrary point of the water supply line L extending from an outlet end of the flow rate sensor 70.

In some implementations, a purified water discharge valve 66 may be mounted at an end of the water supply line L extending from the outlet end of the flow rate sensor 70. Further, a hot water discharge valve 64 may be mounted at an end of the water supply line L1 for supplying the hot water. Further, a cold water discharge valve 65 may be mounted at an end of the water supply line L3 for supplying the cold water. Further, a cooling water valve 63 may be mounted at an arbitrary point of the water supply line L2 for supplying the cooling water. The cooling water valve 63 adjusts an amount of cooling water supplied to a cold water generating unit 20.

In some implementations, all of water supply lines respectively extending from outlet ends of the hot water discharge valve 64, the cold water discharge valve 65, and the purified water discharge valve 66 are connected to the water discharge hole. Further, as shown, the purified water, cold water, and hot water may be connected to a single discharge hole, or may be connected to independent discharge holes, respectively, in some cases.

Hereinafter, cold water and hot water supply processes will be described.

First, in the case of the cold water, when the cooling water valve 63 is opened and the cooling water is supplied to the cold water generating unit 20, cold water is generated as the water in the water supply line L3 for supplying the cold water passing through the cold water generating unit 20 is cooled by the cooling water.

In some implementations, the water supply line L2 for supplying the cooling water may be provided with a refrigerant cycle for cooling the cooling water. The refrigerant cycle may include a compressor, a condenser, an expansion valve, an evaporator, and the like.

Thereafter, when the cold water discharge valve 65 is opened by pressing a cold water selection button of an operation display, the cold water may be discharged through the water discharge hole.

Further, in the case of the hot water, when hot water is generated as water flowing along the water supply line L1 for supplying the hot water is heated by a hot water heater 30, and the hot water discharge valve 64 is opened by pressing a hot water selection button of the operation display, the hot water may be discharged through the water discharge hole.

In some examples, the water purifier may include at least one water purifier filter to generate purified water from raw water. The water purifier filter will be described below.

Hereinafter, a filter for a water purifier will be described.

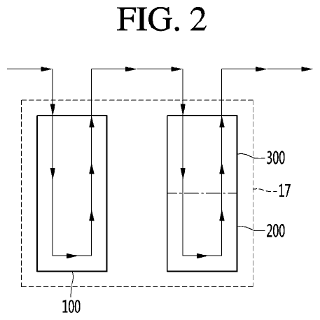

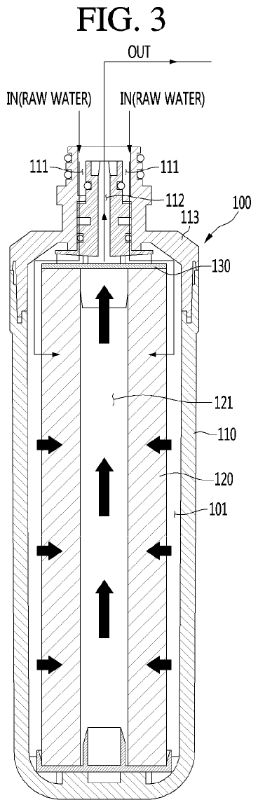

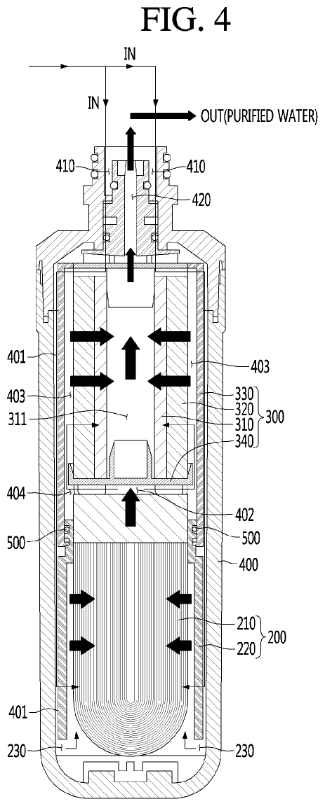

FIG. 2 is a conceptual diagram showing an example of a filter assembly. FIG. 3 is a cross-sectional view showing an example of a pre carbon filter. FIG. 4 is a cross-sectional view showing an example of a composite filter.

Referring to FIGS. 2 to 4, a filter for a water purifier (hereinafter, referred to as a filter assembly) according to one implementation of the present disclosure includes a pre carbon filter 100 and a composite filter 200 and 300.

The pre carbon filter 100 may have a first carbon block 120 in a form of a hollow tube embedded therein. A detailed description of the pre carbon filter 100 will be described below.

In some implementations, the composite filter 200 and 300 may include a hollow fiber membrane filter 200 having a plurality of hollow fiber membranes 210 embedded therein and a post carbon filter 300 having a second carbon block 310 in a hollow tube form embedded therein.

Hereinafter, the composite filter 200 and 300 will be described.

In some implementations, the hollow fiber membrane filter 200 and post carbon filter 300 may be accommodated in one filter housing 400 to form the composite filter 200 and 300.

For example, the hollow fiber membrane filter 200 and the post carbon filter 300 may be arranged in a line such that water passed through the hollow fiber membrane filter 200 passes through the post carbon filter 300. In detail, the hollow fiber membrane filter 200 is disposed at a lower side, and the post carbon filter 300 is disposed at an upper side. In addition, water flowed into the filter housing 400 passes through the hollow fiber membrane filter 200 and the post carbon filter 300 in order, while flowing from the lower side to the upper side.

The post carbon filter 300 includes a second inner cover 330 accommodated inside the filter housing 400 and a second carbon block 310 accommodated inside the second inner cover 330. In addition, an electrostatic attraction non-woven fabric 320 may be provided between the second inner cover 330 and the second carbon block 310. In some cases, the non-woven fabric 320 may include fibers made of fabric-like materials and bonded together rather than woven or knitted.

The electrostatic attraction non-woven fabric 320 may surround an outer surface of the second carbon block 310.

When the electrostatic attraction non-woven fabric 320 is provided on the outer surface of the second carbon block 310 as described above, water flowed into the second inner cover 330 passes through the electrostatic attraction non-woven fabric 320 and then passes through the second carbon block 310.

As described above, when the water flowed into the second inner cover 330 passes through the electrostatic attraction non-woven fabric 320, heavy metals such as chromium (Cr) and selenium (Se) in the water may be removed.

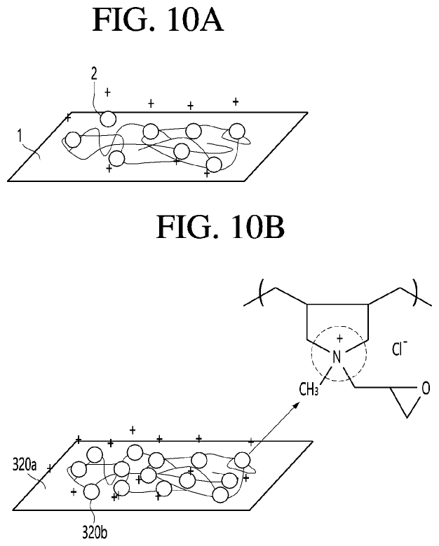

FIGS. 10A and 10B are views comparing an example of an electrostatic attraction mechanism in related art and an example of an electrostatic attraction mechanism according to the present disclosure.

In detail, FIG. 10A is a view illustrating the electrostatic attraction mechanism in related art. FIG. 10B is a view illustrating the electrostatic attraction mechanism on the electrostatic attraction non-woven fabric according to the present disclosure.

Referring to FIG. 10A, an electrostatic attraction material positively charged by coating nano-alumina particles 2 on a glass fiber support 1 was used. However, there was a risk of elution of a material such as boron or aluminum.

Referring to FIG. 10B, in the present disclosure, the problem of elution safety was solved by applying an electrostatic attraction material 320b to which a polyamine-based polymer positively charged functional group was applied to a cellulose support 320a.

In some examples, a virus becomes negatively charged in tap water (neutral pH). When the virus passes through a filter including the electrostatic attraction non-woven fabric 320, the virus is removed by being electrostatically attracted by the positively charged functional group.

Referring to FIGS. 10A and 10B, when the water flowed into the second inner cover 330 passes through the electrostatic attraction non-woven fabric 320, it may be seen that the viruses and micro-particles in the water may be adsorbed and removed through positive charge adsorption.

The electrostatic attraction non-woven fabric 320 may be referred to as a ‘positive charge adsorption non-woven fabric’ in terms of a function. In some cases, the electrostatic attraction non-woven fabric 320 may be a different material from an ‘anion non-woven fabric’.

In some implementations, the electrostatic attraction non-woven fabric 320 may be provided in multiple layers to improve a virus removal efficiency.

In addition, the electrostatic attraction non-woven fabric 320 may be formed to be wrinkled to improve the virus removal efficiency.

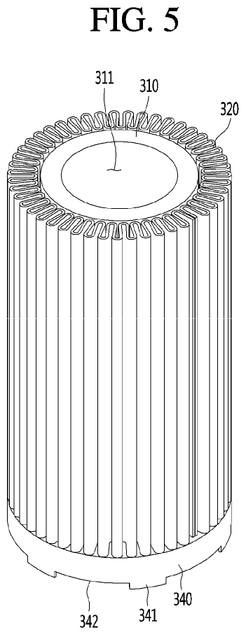

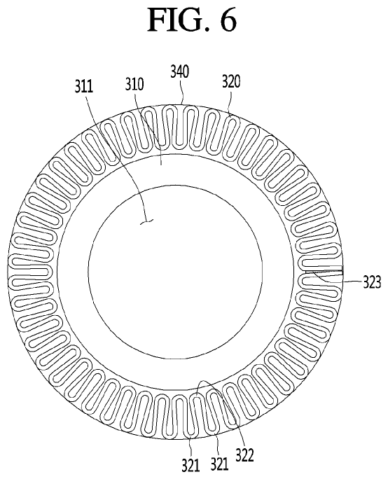

FIG. 5 is a perspective view illustrating an example of a post carbon filter without a second inner cover. FIG. 6 is a top plan view showing an example of a post carbon filter without a second inner cover.

Referring to FIGS. 5 to 6, the electrostatic attraction non-woven fabric 320 may be wrinkled along a circumference of the second carbon block 310.

In some implementations, the electrostatic attraction non-woven fabric 320 may include a plurality of convex portions 321 convex outward from the second carbon block 310 and a plurality of concave portions 322 provided between the convex portions 321.

The convex portions 321 and the concave portions 322 may be alternately formed along the circumference of the second carbon block 310 to form the electrostatic attraction non-woven fabric 320. For instance, each of the plurality of concave portions 322 is disposed between two adjacent convex portions 321.

When the electrostatic attraction non-woven fabric 320 is formed to be wrinkled, a surface area of the electrostatic attraction non-woven fabric 320 is increased. Thus, the heavy metals in the water may be more reliably removed.

Referring to FIG. 6, the electrostatic attraction non-woven fabric 320 may form a closed curve by pleating a rectangular non-woven fabric and thermally bonding both ends of the pleated non-woven fabric being in contact with each other. In this state, the electrostatic attraction non-woven fabric 320 may be fitted to surround an outer circumferential surface of the second carbon block 310. In this connection, a thermal bonding portion 323 may be formed on the electrostatic attraction non-woven fabric 320 while thermally bonding the both ends of the electrostatic attraction non-woven fabric 320.

As another example, the electrostatic attraction non-woven fabric 320 may be thermally bonded in a state in which the pleated non-woven fabric surrounds the outer circumferential surface of the second carbon block 310 and then the both ends of the non-woven fabric are in contact with each other.

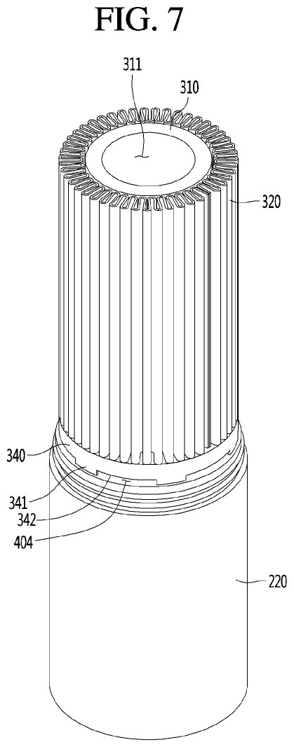

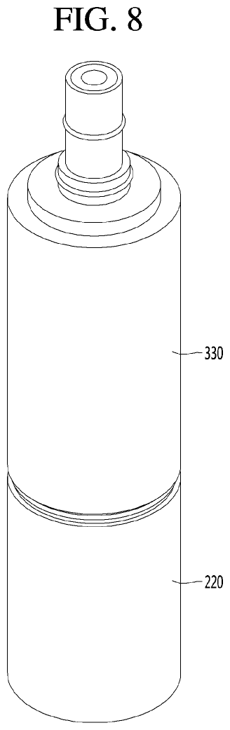

FIG. 7 is a perspective view illustrating the post carbon filter shown in FIG. 5 coupled with an example of a hollow fiber membrane filter. FIG. 8 is a perspective view illustrating an example of a post carbon filter and a hollow fiber membrane filter that are coupled to each other.

Referring to FIGS. 4 to 8, inside the filter housing 400, the hollow fiber membrane filter 200 is disposed below the post carbon filter 300.

Further, the water flowed into the filter housing 400 passes first through the hollow fiber membrane filter 200 and then passes through the post carbon filter 300.

Further, the water flowed into the second inner cover 330 of the post carbon filter 300 first passes through the electrostatic attraction non-woven fabric 320 and then passes through the second carbon block 310.

In some examples, a first inner cover 220 forming an outer surface of the hollow fiber membrane filter 200 is disposed inside the filter housing 400.

That is, the hollow fiber membrane filter 200 includes the plurality of hollow fiber membranes 210 and the first inner cover 220 for accommodating the hollow fiber membranes 210 therein.

The first inner cover 220 may be disposed below the second inner cover 330 and the first inner cover 220 may be detachably coupled to the second inner cover 330.

The first inner cover 220 and the second inner cover 330 may be in a form of the hollow tube having open top and open bottom.

In addition, a communication hole 230 for communicating outside and inside of the first inner cover 220 is defined in the first inner cover 220.

The water flowed into the filter housing 400 through an inlet 410 flows downward along a first flow passage 401 (see FIG. 4) provided between an inner face of the filter housing 400 and outer faces of the first and second inner covers 220 and 330.

Further, the water flowed downward along the first flow passage 401 may flow into the first inner cover 220 through the communication hole 230 defined below the first inner cover 220.

The communication hole 230 may be defined by a spaced distance between the bottom of the first inner cover 220 and an inner bottom face of the filter housing 400.

In addition, the water flowed into the first inner cover 220 is filtered while passing through the plurality of hollow fiber membranes (210, UF), then discharged upwardly of the hollow fiber membrane filter 200, and then flowed into the second inner cover 330.

The top of the hollow fiber membrane filter 200 is opened.

Therefore, the water passed through the plurality of hollow fiber membranes 210 naturally flows upwardly of the hollow fiber membrane filter 200 by flow of the water flowed into the first inner cover 220.

In one example, a filter bracket 340 coupled to a bottom of the second carbon block 310 and a bottom of the electrostatic attraction non-woven fabric 320 is seated on a top of the hollow fiber membrane filter 200. The water discharged upwardly of the hollow fiber membrane filter 200 flows through a second flow passage 402 (see FIG. 4) provided between the top of the hollow fiber membrane filter 200 and a bottom face of the filter bracket 340.

In detail, the top of the hollow fiber membrane filter 200 and the filter bracket 340 is kept spaced apart from each other, and the water passed through the hollow fiber membrane filter 200 may flow through the second flow passage 402 (see FIG. 4) provided in the space therebetween.

In some examples, the bottom of the electrostatic attraction non-woven fabric 320 may be fixed to the filter bracket 340 in a hot melt scheme.

In one example, in order to secure the second flow passage 402 (see FIG. 4), as described above, the filter bracket 340 forms an extension 341 protruding downward on a peripheral portion of the bottom face thereof and defines a through groove 342 concave upwardly of a bottom of the extension 341.

The through groove 342 may include a plurality of through grooves.

The bottom of the filter bracket 340 and the top of the hollow fiber membrane filter 200 may be spaced apart from each other by the extension 341, thereby securing the second flow passage 402 (see FIG. 4).

Further, the water flowing through the second flow passage 402 is discharged through a through hole 404 (see FIG. 7) defined by the through groove 342 and the top of the hollow fiber membrane filter 200 and then flowed to a third flow passage 403 (see FIG. 4) provided between the electrostatic attraction non-woven fabric 320 and the second inner cover 330.

In this connection, the top of the hollow fiber membrane filter 200 and the filter bracket 340 are accommodated in a lower side of the second inner cover 330.

Accordingly, the water flowing through the second flow passage 402 may be discharged through the through hole 404 (see FIG. 7) and then flow into the third flow passage 403 (see FIG. 4).

Further, the water flowed into the third flow passage 403 passes through the electrostatic attraction non-woven fabric 320 and the second carbon block 310 in order, flows into a hollow 311 of the second carbon block 310, and then is discharged outwardly of the filter housing 400 through an outlet 420 of the filter housing 400 while flowing upward.

In addition, the top of the first inner cover 220 may be inserted into the bottom of the second inner cover 330 and a sealing member 500 may be inserted between the top of the first inner cover 220 and the bottom of the second inner cover 330.

In this connection, an accommodating groove concave inward to accommodate the sealing member 500 therein may be defined in an outer face of the first inner cover 220 or in an inner face of the second inner cover 330.

In some implementations, the bottom of the second inner cover 330 may be inserted into the top of the first inner cover 220.

In some examples, the first inner cover 220 and the second inner cover 330 may be integrally formed.

Hereinafter, a flow process of water flowed into the composite filter 200 and 300 configured as described above will be described.

First, water is introduced through the inlet 410 formed at the upper side of the filter housing 400. For example, the introduced water may be water that has passed through the pre carbon filter 100.

In addition, the water flowed into the inlet 410 flows downward along the first flow passage 401 provided between the outer faces of the first and second inner covers 220 and 330 and the inner face of the filter housing 400.

In addition, the water in the first flow passage 401 is flowed into the first inner cover 220 through the communication hole 230 provided below the first inner cover 220.

As described above, the water flowed into the first inner cover 220 is filtered while passing through the plurality of hollow fiber membranes 210 accommodated in the first inner cover 220 and then discharged upward.

As described above, the water discharged upwardly of the hollow fiber membrane 210 flows through the second flow passage 402 provided between the top of the hollow fiber membrane filter 200 and the filter bracket 340 and then is discharged through the through hole 404.

The water discharged through the through hole 404 is flowed into the third flow passage 403 provided between the inner face of the second inner cover 330 and the electrostatic attraction non-woven fabric 320.

Further, the water flowed into the third flow passage 403 passes through the electrostatic attraction non-woven fabric 320 and the second carbon block 310 in order and then flows into the hollow 311 of the second carbon block 310. Further, the water flowed into the hollow 311 may be discharged outwardly of the filter housing 400 through the outlet 420 provided at a top center portion of the filter housing 400.

In this connection, the electrostatic attraction non-woven fabric 320 is formed to be wrinkled along the circumference of the second carbon block 310, so that the surface area of the electrostatic attraction non-woven fabric 320 may be increased and the heavy metals in the water may be more reliably removed.

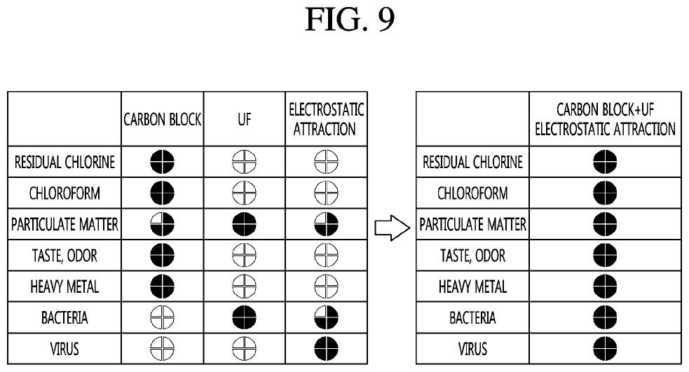

FIG. 9 is a table showing example components to be removed by individual filters and a composite filter.

Referring to FIG. 9, the carbon block may remove residual chlorine, chloroform, particulate matter, taste, odor, heavy metals.

The hollow fiber membrane may remove the particulate matter and bacteria.

The electrostatic attraction non-woven fabric may remove the particulate matter, the bacteria, and viruses.

In some implementations, when the water flowed into the filter housing passes through the hollow fiber membrane, the electrostatic attraction non-woven fabric, and the carbon block in order, the residual chlorine, chloroform, particulate matter, heavy metals, bacteria, and viruses may be removed.

In addition, since the water flowed into the filter housing finally passes through the carbon block, the odor is removed and the water taste is improved.

In one example, as described above, when the hollow fiber membrane filter 200 and the post carbon filter 300 are arranged in a line in one filter housing 400, a purified water flow rate may be maintained while increasing a filtration efficiency.

In some examples, without a need to expand a filter installation space defined in the water purifier, the present disclosure may be applied immediately by simply replacing the existing filter.

In some examples, a space utilization may be increased by reducing a volume of the filter and further the water purifier may be implemented slimly.

Hereinafter, the pre carbon filter 100 will be described.

The pre carbon block 100 includes a filter housing 110 formed with the inlet 111 and the outlet 112 and the first carbon block 120 accommodated inside the filter housing 110.

The first carbon block 120 and the second carbon block 310 described above may contain activated carbon.

The activated carbon may be contained in a form of granular or powder. As described above, when the carbon blocks 120 and 310 contain the activated carbon, the carbon blocks 120 and 310 may remove the heavy metal in the water and effectively remove the residual chlorine in the water at the same time. Accordingly, the taste of the water may also be improved.

In addition, the chloroform (CHCl₃) in the water may be effectively removed by the activated carbon.

In some examples, each of the first carbon block 120 and the second carbon block 310 described above contains a binder.

The binder is mixed to connect the activated carbon and a functional material, which is selectively mixed, with each other and to give rigidity.

With the configuration of the binder, the activated carbon and the functional material may be processed into a block form having the rigidity.

For example, the functional material may include titanium oxide (e.g., Na₄TiO₄) and iron hydroxide (Ferric Hydroxide).

That is, the first carbon block 120 or the second carbon block 310 may be produced by mixing the activated carbon and the binder with each other, or may further include the titanium oxide (e.g., Na₄TiO₄) and the iron hydroxide (Ferric Hydroxide).

In some examples, the first carbon block 120 or the second carbon block 310 may be formed by uniformly mixing a plurality of materials, including the activated carbon and the binder, with each other to generate a mixture, then putting the mixture into a mold, and then heating the mixture. The binder (for example, polyethylene, PE) is melted by the heating in the mold, so that the materials such as the activated carbon are bonded with each other. Therefore, the first carbon block 120 or the second carbon block 310 in the block form with the rigidity may be formed.

In addition, the pre carbon filter 100 may further include a filter bracket 130 accommodated inside the filter housing 110 and coupled to top and bottom of the first carbon block 120.

In addition, the top of the filter housing 110 may be opened. The open top of the filter housing 110 may be blocked by a separate cap 113 and opened selectively depending on whether the cap 113 is separated therefrom.

The water flowed into the filter housing 110 through the inlet 111 flows along a flow passage 101 provided between the inner face of the filter housing 110 and the first carbon block 120. Further, the water flowing along the flow passage 101 is filtered while passing through the first carbon block 120 and then flows into a hollow portion 121 of the first carbon block 120.

Thereafter, the water of the hollow portion 121 is discharged outwardly of the filter housing 110 through the outlet 112 while flowing upward. Further, the discharged water flows into the composite filter 200 and 300.

In some implementations, while the raw water flowed into the filter housing 110 passes through the first carbon block 120, the heavy metals may be removed and the raw water may be purified.

As described above, the raw water flowed into the pre carbon filter 100 passes through the first carbon block 120, then passes through the hollow portion 121 of the first carbon block 120, and then is discharged outwardly of the pre carbon filter 100.

In some implementations, the water discharged outwardly of the pre carbon filter 100 passes through the hollow fiber membrane filter 200 including the plurality of hollow fiber membranes 210 therein and the post carbon filter 300 including the second carbon block 310 in the hollow tube shape and the electrostatic attraction non-woven fabric 320 surrounding the circumference of the second carbon block 310 therein.

When the pre carbon filter 100, the hollow fiber membrane filter 200, and the post carbon filter 300 are included as described above, as the water flowed into the water supply line L passes through the pre carbon filter 100, the hollow fiber membrane filter 200, and the post carbon filter 300, the water purification takes place several times. Thus, the removal of various foreign substances, including the heavy metals, the bacteria, and the viruses proceeds more effectively.

In particular, the chlorine component and the chloroform (CHCl₃) in the water may be more reliably removed by the post carbon filter 300 and the taste of the water may be improved.

In some examples, when the water passes through the first carbon block 120 or the second carbon block 310 in which the activated carbon, the binder, the iron hydroxide, the titanium oxide are mixed with each other, nine kinds of heavy metals, that is, mercury, lead, copper, aluminum, iron, cadmium, arsenic, manganese, and zinc may be reduced therefrom.

In detail, the mercury, the lead, the iron, the aluminum, the cadmium, the arsenic, and the copper may be removed by the iron hydroxide in the carbon blocks 120 and 310 and the manganese and the zinc may be reduced by the titanium oxide in the carbon blocks 120 and 310.

Hereinafter, a producing process of the carbon blocks 120 and 310, which are components of the present disclosure, will be briefly described.

First, each material constituting the carbon blocks 120 and 310 are mixed with each other in proportions to produce a carbon block mixture.

Further, the evenly mixed carbon block mixture is filled in the mold. Then, the carbon block mixture is subjected to a compression process and then is put into an electric furnace.

Then, the carbon block mixture is heated. In the heating process, the binder, for example, the polyethylene (PE) is melted, so that the activated carbon, the iron hydroxide, the titanium oxide, and the binder may be integrally bonded to each other and then the hollow tube-shaped carbon blocks 121 and 310 with the rigidity may be formed.

In some examples, after the heating, the carbon blocks may be cooled. When the cooling is finished, the mold may be separated from the carbon blocks.

In some examples, the carbon blocks in the form of the hollow tube separated from the mold may be cut into a unit length. For example, the second carbon block 310 may be cut to be shorter than the first carbon block 120.

In cases, the carbon blocks 120 and 310, which had been cut, are washed through compressed air injection.

Thereafter, the non-woven fabric surrounds the carbon block and then upper and lower caps are attached thereto in a hot melt scheme.

Thereafter, a dimension, a weight, and the like of the carbon block are checked. When there is no abnormality, a packaging of the carbon block is performed.

In some implementations, the residual chlorine, the chloroform, the particulate matter, the taste, the odor, the heavy metals contained in the water may be removed.

In some implementations, the bacteria contained in the water may be removed.

In some implementations, the virus contained in the water may be removed.

In some implementations, since the water flowed into the filter housing finally passes through the carbon block, the odor may be removed and the taste of the water may be improved.

In some implementations, when the hollow fiber membrane filter and the post carbon filter are arranged in a line in one filter housing, the filtration efficiency may be increased while maintaining the purified water flow rate.

In some implementations, without the need to expand the filter installation space defined in the water purifier, the present disclosure may be applied immediately by simply replacing the existing filter.

In some implementations, the space utilization may be increased by reducing the volume of the filter and further the water purifier may be implemented slimly.

What is claimed is:

1. A filter for a water treatment apparatus, the filter comprising:
a filter housing that defines an inlet of the filter and an outlet of the filter; and
a filter module disposed inside the filter housing and configured to purify water received through the inlet and supply purified water to the outlet, the filter module comprising:
a carbon block that has a hollow tube-shape and that comprises a mixture of activated carbon and a binder, and
a non-woven fabric that surrounds an outer circumferential surface of the carbon block, the non-woven fabric comprising an electrostatic attraction material,
wherein the filter module is configured to receive water through the inlet, transmit the water through the non-woven fabric and the carbon block in sequence to thereby purify the water, and then discharge the purified water to the outlet of the filter.

2. The filter of claim 1, wherein the non-woven fabric has a wrinkled shape arranged along a circumference of the carbon block.

3. The filter of claim 2, wherein the non-woven fabric comprises a plurality of convex portions that protrude outward relative to the circumference of the carbon block and a plurality of concave portions, each of the plurality of concave portions being disposed between the plurality of convex portions.

4. The filter of claim 1, further comprising a fiber membrane filter comprising a hollow fiber membrane that is disposed inside the filter housing and that is positioned vertically below the non-woven fabric and the carbon block,
wherein the fiber membrane filter is configured to receive water entered into the filter housing and then transmit water upward to the non-woven fabric and the carbon block.

5. The filter of claim 4, further comprising:
a first inner cover that is accommodated inside the filter housing, that defines an outer surface of the fiber membrane filter, and that covers the hollow fiber membrane; and
a second inner cover that is accommodated inside the filter housing, that is disposed vertically above the first inner cover, and that covers an outer surface of the non-woven fabric.

6. The filter of claim 5, wherein the first inner cover defines a communication hole at a lower position of the first inner cover, the communication hole being configured to communicate water between an outside of first inner cover and an inside of the first inner cover, and
wherein an inner surface of the filter housing and outer surfaces of the first and second inner covers define a first flow passage configured to guide downward water entered into the filter housing to the inside of the first inner cover through the communication hole.

7. The filter of claim 6, wherein the fiber membrane filter is configured to receive and filter water entered into the inside of the first inner cover through the communication hole and to discharge the water in an upward direction from the inside of the first inner cover to the second inner cover.

8. The filter of claim 7, further comprising:
a filter bracket seated on a top portion of the fiber membrane filter and coupled to bottom portions of the carbon block and the non-woven fabric,
wherein the filter bracket defines a second flow passage between the top portion of the fiber membrane filter and a bottom portion of the filter bracket, the second flow passage being configured to guide water discharged upward from the fiber membrane filter.

9. The filter of claim 8, wherein the filter bracket comprises an extension that protrudes downward and that extends along a circumference of the filter bracket, the filter bracket defining a through groove that is recessed upward relative to a bottom of the extension, and
wherein the through groove corresponds to a through hole that is defined between the extension and the top portion of the fiber membrane filter and that is configured to discharge water guided through the second flow passage into a third flow passage defined between the outer surface of the non-woven fabric and an inner surface of the second inner cover.

10. The filter of claim 9, wherein the carbon block defines a hollow portion that is configured to receive water having been guided by the third flow passage and then passed through the non-woven fabric and the carbon block, the hollow portion being configured to discharge water in the upward direction out of the filter housing.

11. The filter of claim 5, wherein a top portion of the first inner cover is inserted into a bottom portion of the second inner cover, and
wherein the filter further comprises a sealing member inserted between the top portion of the first inner cover and the bottom portion of the second inner cover.

12. The filter of claim 1, wherein the non-woven fabric comprises a rectangular fabric that is pleated into a closed curve shape and that has ends thermally bonded to each other, and
wherein the non-woven fabric contacts the outer circumferential surface of the carbon block.

13. A water treatment apparatus comprising at least one filter configured to produce purified water from raw water, the at least one filter comprising:
a filter housing that defines an inlet of the filter and an outlet of the filter; and
a filter module disposed inside the filter housing and configured to purify water received through the inlet and supply purified water to the outlet, the filter module comprising:
a carbon block that has a hollow tube-shape and that comprises a mixture of activated carbon and a binder, and
a non-woven fabric that surrounds an outer circumferential surface of the carbon block, the non-woven fabric comprising an electrostatic attraction material,
wherein the filter module is configured to receive water through the inlet, transmit the water through the non-woven fabric and the carbon block in sequence to thereby purify the water, and then discharge the purified water to the outlet of the filter.

14. The water treatment apparatus of claim 13, wherein the filter further comprises:
a fiber membrane filter comprising a hollow fiber membrane that is disposed inside the filter housing and that is positioned vertically below the non-woven fabric and the carbon block, and
wherein the fiber membrane filter is configured to receive water entered into the filter housing and then transmit water upward to the non-woven fabric and the carbon block.

15. The water treatment apparatus of claim 14, wherein the at least one filter further comprises:
a first inner cover that is accommodated inside the filter housing, that defines an outer surface of the fiber membrane filter, and that covers the hollow fiber membrane; and
a second inner cover that is accommodated inside the filter housing, that is disposed vertically above the first inner cover, and that covers an outer surface of the non-woven fabric.

16. The water treatment apparatus of claim 15, wherein the first inner cover defines a communication hole at a lower position of the first inner cover, the communication hole being configured to communicate water between an outside of first inner cover and an inside of the first inner cover, and
wherein an inner surface of the filter housing and outer surfaces of the first and second inner covers define a first flow passage configured to guide downward water entered into the filter housing to the inside of the first inner cover through the communication hole.

17. The water treatment apparatus of claim 16, wherein the fiber membrane filter is configured to receive and filter water entered into the inside of the first inner cover through the communication hole and then discharge the water in an upward direction from the inside of the first inner cover to the second inner cover.

18. The water treatment apparatus of claim 17, wherein the at least one filter further comprises:
a filter bracket seated on a top portion of the fiber membrane filter and coupled to bottom portions of the carbon block and the non-woven fabric, and
wherein the filter bracket defines a second flow passage between the top portion of the fiber membrane filter and a bottom portion of the filter bracket, the second flow passage being configured to guide water discharged upward from the fiber membrane filter.

19. The water treatment apparatus of claim 18, wherein the filter bracket comprises an extension that protrudes downward and that extends along a circumference of the filter bracket, the filter bracket defining a through groove that is recessed upward relative to a bottom of the extension, and
wherein the through groove corresponds to a through hole that is defined between the extension and the top portion of the fiber membrane filter and that is configured to discharge water guided through the second flow passage into a third flow passage defined between the outer surface of the non-woven fabric and an inner surface of the second inner cover.

20. The water treatment apparatus of claim 19, wherein the carbon block defines a hollow portion that is configured to receive water having been guided by the third flow passage and then passed through the non-woven fabric and the carbon block, the hollow portion being configured to discharge water in the upward direction out of the filter housing.
